(19) United States
(12) Patent Application Publication
(10) Pub. No.: US 2019/0350230 A1
(43) Pub. Date: Nov. 21, 2019

(54) FOOD PRODUCT CARRIERS FOR PARTIALLY COMPRESSING FOOD PRODUCTS DURING PROCESSING WITH ELECTROMAGNETIC WAVE FOOD PROCESSING SYSTEMS

(71) Applicant: Campbell Soup Company, Camden, NJ (US)

(72) Inventor: Mark Robert Watts, Marlton, NJ (US)

(21) Appl. No.: 16/412,877

(22) Filed: May 15, 2019

Related U.S. Application Data
(60) Provisional application No. 62/673,182, filed on May 18, 2018.

(51) Int. Cl. A23L 3/01; B65B 55/14; A23L 3/10; B65D 81/34; H05B 6/64

(52) U.S. Cl. CPC A23L 3/01; B65B 55/14; A23V 2002/00; B65D 81/3461; H05B 6/6408; A23L 3/10

(57) ABSTRACT

The present application relates to food product carriers for microwave or radiofrequency sterilization or pasteurization of food products. In an embodiment, a method of processing a hermetically sealed packaged food product with microwave or radiofrequency energy to achieve sterilization or pasteurization is included. The method can include loading one or more hermetically sealed packaged food products into a carrier, the hermetically sealed packaged food products having a non-uniform thickness. The carrier can include a first press plate and a second press plate. The method can further include reducing a gap distance between the first press plate and the second press plate sufficiently to compress a portion of the hermetically sealed packaged food product and applying at least one of microwave or radiofrequency energy to the food product to result in sterilization or pasteurization. Other embodiments are also included herein.

This application claims the benefit of U.S. Provisional Application No. 62/673,182, filed May 18, 2018, the content of which is herein incorporated by reference in its entirety.

### FIELD OF THE TECHNOLOGY

The present application relates to microwave or radiofrequency sterilization or pasteurization of food products. More specifically, the present application relates to food product carriers for microwave or radiofrequency sterilization or pasteurization of food products.

### BACKGROUND

Most food products tend to spoil relatively quickly. As such, preservation techniques have been developed over many years to extend the amount of time that a given food product will remain fresh. Food preservation techniques can include dehydrating, freezing, fermenting, pickling, acidification, curing, canning, heat treating, retort sterilization, irradiating, chemical preservation and the like.

Retort sterilization typically involves the application of heat to hermetically sealed packages of food through thermal conduction. Retort sterilization allows for packaged non-frozen and non-dehydrated ready-to-eat foods that can have a shelf life of months to years.

While food preservation techniques, such as retort sterilization, have been successful at preventing food spoilage, it has been found that such techniques can have adverse effects on food products including, diminishing taste and appearance, reducing nutritional qualities, and the like.

Another approach to sterilization and/or pasteurization has been the application of electromagnetic wave energy (such as microwave or radiofrequency wave energy). However, the use of electromagnetic wave energy for sterilization and/or pasteurization at commercial scale has proven difficult.

### SUMMARY

The present application relates to food product carriers for microwave or radiofrequency sterilization or pasteurization of food products. In an embodiment, a method of processing a hermetically sealed packaged food product with microwave or radiofrequency energy to achieve sterilization or pasteurization is included. The method can include loading one or more hermetically sealed packaged food products into a carrier, the hermetically sealed packaged food products having a non-uniform thickness. The carrier can include a first press plate comprising an inner surface, the first press plate comprising a microwave and radiofrequency transparent material. The carrier can include a second press plate comprising an inner surface, the second press plate comprising a microwave and radiofrequency transparent material. The inner surface of the first press plate and the inner surface of the second press plate are spaced apart from one another by a gap distance. The method can further include reducing the gap distance between the first press plate and the second press plate sufficiently to compress a portion of the hermetically sealed packaged food product. The method can further include applying at least one of microwave or radiofrequency energy to the hermetically sealed packaged food product to result in sterilization or pasteurization of the hermetically sealed packaged food product.

In an embodiment, a carrier for holding packaged food products during a sterilization or pasteurization process conducted in a radiofrequency or microwave system is included. The carrier can include a first press plate comprising an inner surface, the first press plate comprising a microwave and radiofrequency transparent material. The carrier can also include a second press plate comprising an inner surface, the second press plate comprising a microwave and radiofrequency transparent material. The inner surface of the first press plate and the inner surface of the second press plate are spaced apart from one another by a gap distance. The carrier configured to be switched between a loading configuration where the gap distance is expanded to allow placement of a packaged food product into the carrier and a processing configuration where the gap distance is contracted to apply pressure to a portion of the packaged food product and change its shape.

In an embodiment, a system for processing food products is included. The system can include a carrier comprising a first press plate comprising an inner surface and a second press plate comprising an inner surface. The inner surface of the first press plate and the inner surface of the second press plate are spaced apart from one another by a gap distance. The first press plate and the second press plate can be configured to be switched between a loading configuration where the gap distance can be expanded and a processing configuration where the gap distance cannot be expanded, wherein the first press plate and the second press plate both comprise microwave and radiofrequency transparent material. The system can include a product conveyor mechanism to convey the one or more carriers to be processed continuously along a conveyance path passing through a loading station and a sterilization chamber. The system can include a loading station configured to dispose a packaged food product into a carrier. The system can further include a sterilization station comprising an electromagnetic wave emitting apparatus configured to emit electromagnetic energy into the packaged food product, the electromagnetic wave emitting apparatus comprising one or more electromagnetic wave units.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE FIGURES

The technology may be more completely understood in connection with the following drawings, in which:

FIG. 1 is a schematic front view of an example of a food package.

FIG. 2 is a schematic side view of the food package in FIG. 1.

FIG. 3 is a schematic cross-sectional view of a sealed packaged food product, according to various embodiments.

FIG. 4 is a schematic cross-sectional view of a sealed packaged food product, according to various embodiments.

FIG. 5 is a schematic cross-sectional view of a sealed packaged food product, according to various embodiments.

FIG. 6 is a schematic cross-sectional view of a carrier, according to various embodiments.

FIG. 7 is a schematic cross-sectional view of a carrier, according to various embodiments.

FIG. 8 is a schematic cross-sectional view of a carrier, according to various embodiments.

FIG. 9 is a schematic cross-sectional view of a carrier, according to various embodiments.

FIG. 10 is a schematic top view of a portion of a carrier, according to various embodiments.

FIG. 11 is a schematic top view of a portion of a carrier, according to various embodiments.

FIG. 12 is a schematic view of a system, according to various embodiments.

FIG. 13 is a flow chart showing a method, according to various embodiments.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

Some packaged food products have irregular shapes, at least in certain dimensions. As just one example, pouches have become a popular packaging format for food products. Some pouches have a thicker and/or gusseted bottom that conveniently allows the pouch to sit on surface in a vertical orientation without tipping over. However, as a result, the thickness of the food product is much greater near the bottom of the pouch than it is at the top of the pouch. This can be problematic because it can lead to uneven heating during microwave and/or radiofrequency based sterilization or pasteurization processes. The thicker portions will generally heat up more slowly than the thinner portions. Therefore, ensuring that the thicker portions have been exposed to at least a threshold temperature for a threshold amount of time generally means that the thinner portions will have been exposed to much higher temperatures leading to thermally-associated degradation in flavor, texture, nutritional value and the like.

In accordance with various embodiments herein, food products can be temporarily put into a more uniform physical shape, which can result in more consistent sterilizing or pasteurizing of a packaged food product. For example, the system can be configured to compress or force the packaged food products into a shape exhibiting a more uniform thickness than the starting shape of the packaged food product. In some embodiments, a more consistent thickness of the packaged food product can be maintained throughout the treatment with electromagnetic waves to sterilize or pasteurize the packaged food product. Thickness of the packaged food product can be more consistent than a packaged food product that is not subjected to the methods, systems, or apparatuses described herein. After processing, the packaged food product can then be returned to its starting shape or a shape very similar thereto.

As used herein, the term “food product” shall include both foods of all types as well as drinks of all types, unless used explicitly to the contrary. Food products herein can include shelf-stable food products, extended shelf-life products, ready-to-eat food products, chilled food products, refrigerated food products, and the like. Food products herein can include acidified and non-acidified food products. By way of example, food products can include food products having a pH of below 4.6 as well as food products having a pH of 4.6 or higher. Food products herein can include high nutritional density food products. Food products herein can include human food products, pet food products, geriatric food products, food products for at-risk populations, baby food products, nutriceuticals, and the like. Food products herein can include, but are not limited to, soups, soups with particulates, sauces, concentrates, condiments, salsas, dips, fruits, vegetables, nut products, grain products, pasta products, food components or ingredients, beverages of all types, dairy products, meat products, fish products, entrees, combinations of any of these, and the like. Food products herein can specifically include flowable food products.

Food packages can be semi-rigid, semi-flexible, or flexible. In various embodiments the food packages herein can be substantially transparent to microwave energy and/or radiofrequency wave energy. In various embodiments portions of food packages herein can be substantially transparent to microwave energy and/or radiofrequency wave energy while other portions can absorb or reflect such energy. Food packages herein can include portions that can expand in order to allow the redistribution of food materials therein. In various embodiments, the expansion of certain portions can occur through a change in the overall package shape (in contrast to stretching of materials used to form the packaging).

It will be appreciated that systems and methods herein can be used for both sterilization and pasteurization processes. In specific, systems and methods herein can be used for both microwave and/or radiofrequency based sterilization and/or pasteurization processes. References to “processing” of food items herein shall include both sterilization and pasteurization unless the context dictates otherwise.

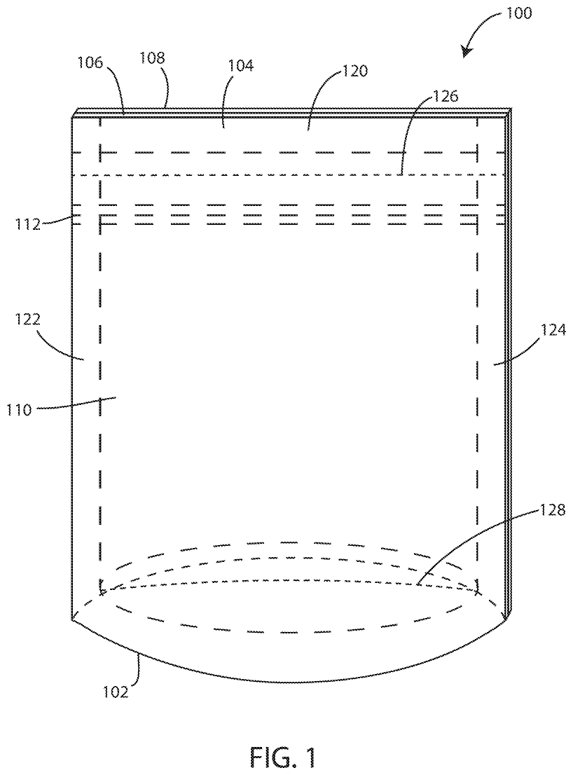

Referring now to FIG. 1, a front view of a food package 100, according to some embodiments, is shown. In various embodiments, the food package 100 can be a flexible or semi-flexible food package 100 such that the food package 100 can be deformed.

In some embodiments, the food package 100 can be configured to stand on a bottom end 102 of the package 100. In some embodiments, the bottom end 102 can include a gusset 128. The bottom end 102 can generally have a larger thickness than the top end 104. The food package 100 can include a first sheet 106 and a second sheet 108. The first sheet 106 and second sheet 108 can be joined along two or more edges, such that the first sheet 106 and the second sheet 108 define an interior volume 110, which can be at least partially filled with a food material, which can be a flowable food material. Specifically, the first sheet 106 and second sheet 108 can be attached at one or more seal zones 120, 122, and 124.

In various embodiments, the package 100 can be hermetically sealed. The package 100 can be airtight, such that air within the package 100 cannot escape and air outside of the package 100 cannot enter the package 100.

In various embodiments, the top end 104 can be configured to open allowing access to the interior volume 110, such as at the point of a consumer opening the package to consume the food material therein. For example, the consumer can tear the package at a tear line 126. The first sheet 106 and the second sheet 108 can remain un-joined along a portion of the top section of the package 100 to allow access to the interior volume 110. In some embodiments, the first sheet 106 and the second sheet 108 can be rejoined, such as to seal or close the food package 100, via a securement strip 112 near the top end 104 of the package 100.

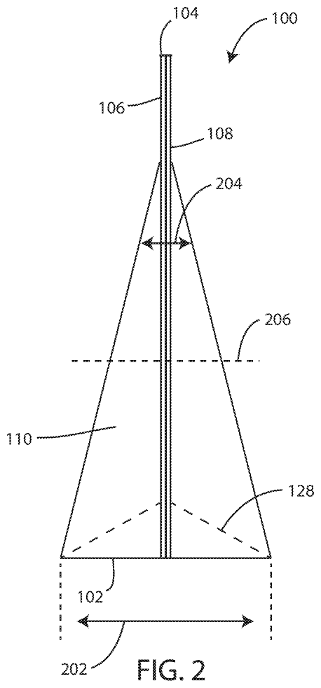

FIG. 2 shows a side view of the food package 100. As can be seen, the thickness 202 near the bottom end 102 of the food package 100, in a starting physical shape, is much larger than the thickness 204 near the top end 104 of the food package 100. In some embodiments, the maximum thickness 202 of the food package 100, in a starting physical shape, near the bottom end 102 is much thicker than at any point above the midpoint 206 between the bottom end 102 and the top end 104.

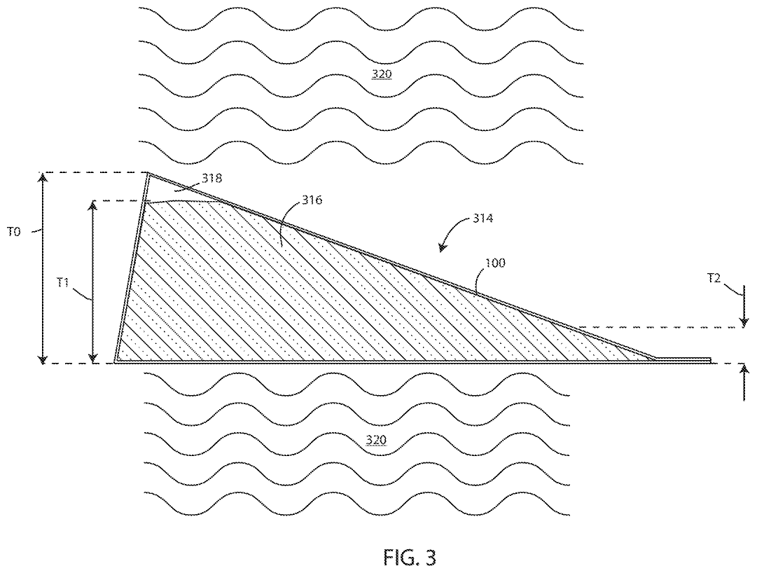

FIG. 3 shows a cross-sectional view of a packaged food product 314, according to various embodiments. The packaged food product 314 can include a package 100 and a food material 316 disposed within the package 100. In various embodiments, the food material 316 can include a flowable food material. A flowable food material 316 can be a food material that takes the shape of the container it is within.

The packaged food product 314 can include a food material 316 and air 318 within the interior volume 110 of the package 100. In some embodiments, the package 100 contains less than 30% air by volume, such that air occupies or fills less than 30% of the interior volume 110. In some embodiments, the package 100 contains less than 25%, 20%, 15%, 10%, 5%, 4%, 3%, 2%, or 1% air by volume (defined by free air, not including entrained air).

FIG. 3 shows the packaged food product 314 laying on its side (it will be appreciated that FIG. 3 is a simplified and idealized view for ease of illustration). Due to the package 100 shape, the food material 316 can be considerably thicker towards the bottom end 102 of the package 100 than it is at the top end 104 of the package 100, such as seen when comparing thickness T1 to thickness T2. The package 100 can also have a maximum thickness T0 that is greater than the maximum thickness T1 of the food material 316.

The packaged food product 314 can be subjected to energy waves 320 to sterilize or pasteurize the packaged food product 314. In this view, the energy waves 320 are shown coming from the top and bottom. However, it will be appreciated that in some embodiments energy waves 320 can also come from the sides and/or the front and the back. The configuration of the packaged food product 314 shown in FIG. 3 can lead to uneven heat exposure of the packaged food product 314. For example, if the packaged food product 314 is subjected to a uniform density of energy waves 320, the portion of the food material 316 closer to the top end 104 of the package 100, such as food material 316 at thickness T1, can absorb more energy and therefore become much hotter due to the increased amount of exposure to the energy waves 320 compared to portions of the food material 316 that are thicker.

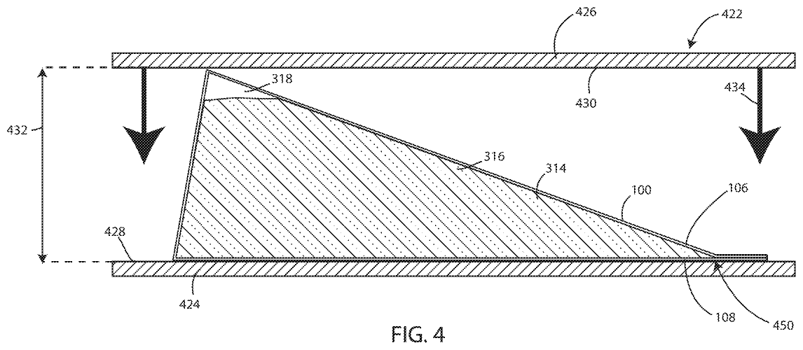

However, in accordance with various embodiments herein, food products can be temporarily put into a more uniform physical shape, which can result in more consistent sterilizing or pasteurizing of a packaged food product. For example, the system can be configured to compress or force the packaged food products into a shape exhibiting a more uniform thickness than the starting shape of the packaged food product. Referring now to FIG. 4, a cross-sectional view is shown of the packaged food product 314 from FIG. 3 with a carrier 422. The carrier 422 can include a first press plate 424 and a second press plate 426. The carrier 422 can include a microwave and/or radiofrequency transparent material. The first press plate 424 and the second press plate 426 can include a microwave and/or radiofrequency transparent material. Exemplary materials that can be used to form the carrier 422 can include, but are not limited to, materials with low dielectric loss characteristics. Exemplary materials can specifically include, but are not limited to, glass (such as borosilicate glass), polymers (including, but not limited to, polyethylene, polypropylene, polycarbonate, and polytetrafluoroethylene), ceramics, composites (including, but not limited to, composites including carbon and/or glass fibers) and the like.

In various embodiments, the packaged food product 314 can be disposed between the first press plate 424 and the second press plate 426. The first press plate 424 can include an inner surface 428 and the second press plate 426 can include an inner surface 430. The inner surface 428 of the first press plate 424 and the inner surface 430 of the second press plate 426 can define a gap distance 432.

The gap distance 432 can be variable, such that in some configurations the gap distance 432 is smaller or larger as compared to the gap distance 432 in other configurations. In an embodiment with the packaged food product 314 can be disposed between the inner surface 428 of first press plate 424 and the inner surface 430 of the second press plate 426, the gap distance 432 can be decreased, such as by moving one or both of the press plates 424, 426 as indicated by arrow 434.

As the gap distance 432 is decreased, at least a portion of the packaged food product 314 can be compressed. The thickest portion of the packaged food product 314 can be compressed and other portions of the packaged food product 314 can be expanded, such as to obtain a more uniform thickness throughout the packaged food product 314. Compressing the thicker portions of the packaged food product 314 can force the food material 316 within the package 100 to move into portions of the package 100 that are not as thick. The package 100 can be made with a flexible material to allow the package 100 to deform along with the food material 316. The first sheet 106 and the second sheet 108 can meet each other at a particular angle 450 near the top end 104.

In some embodiments, the carrier 422 can be in at least two different configurations, a loading configuration and a processing configuration. In the loading configuration, the gap distance 432 can be expanded, such as to allow a packaged food product 314 to be inserted within the carrier 422. In the processing configuration, the gap distance 432 cannot be expanded, such as to restrict the size of the packaged food product 314 to a more uniform thickness.

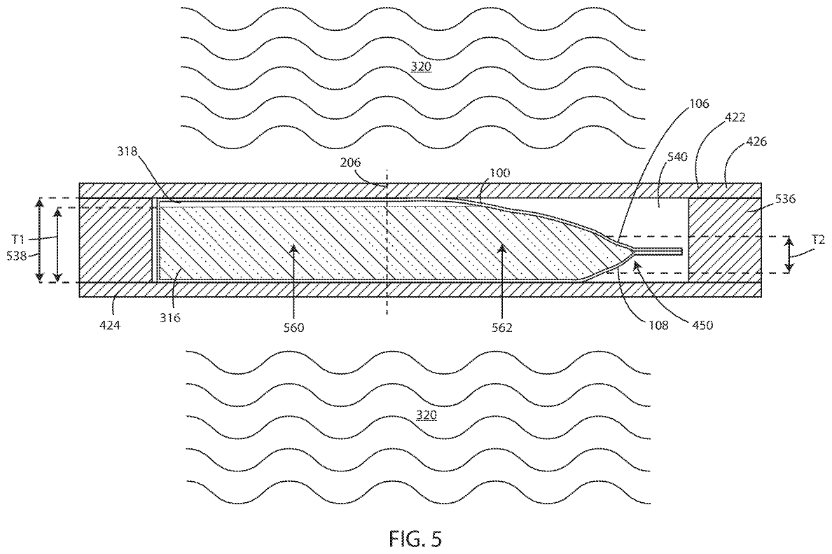

FIG. 5 shows a cross-sectional view of a sealed packaged food product 314 within a carrier 422 in a processing configuration, according to various embodiments. In addition to the first press plate 424 and the second press plate 426, the carrier 422 can further include a carrier frame 536. In various embodiments, the carrier frame 536 can include a microwave and/or radiofrequency transparent material. In some embodiments, the carrier frame 536 can be directly attached or coupled to the first press plate 424, the second press plate 426, or both the first press plate 424 and the second press plate 426.

In some embodiments, the carrier frame 536 can be configured to fit entirely between the first press plate 424 and the second press plate 426. In other embodiments, a portion of the carrier frame 536 can be configured to fit between the first press plate 424 and the second press plate 426, and another portion of the carrier frame 536 can be configured to be outside of the first press plate 424 and/or the second press plate 426 (e.g., not between the first press plate 424 and the second press plate 426). The carrier frame 536 or another element can have a thickness 538 that can define the smallest gap distance 432 between the inner surface 428 of the first press plate 424 and the inner surface 430 of the second press plate 426. In some embodiments, a spacer element can be included that can define the smallest gap distance 432 between the inner surface 428 of the first press plate 424 and the inner surface 430 of the second press plate 426.

The carrier frame 536 can define one or more interior openings 540. The interior openings 540 can be configured for a non-uniform thickness packaged food product 314 to be disposed within, such as when the carrier 422 is in the loading configuration. In some embodiments, the interior openings 540 can be defined in a horizontal direction by the carrier frame 536 and in a vertical direction by the first press plate 424 and the second press plate 426.

In various embodiments, reducing the gap distance 432 between the first press plate 424 and the second press plate 426 can compress a portion of the packaged food product 314 resulting in narrowing a first thickness T1 of the packaged food product 314 and widening a second thickness T2 of the packaged food product 314. In some embodiments, the first thickness T1 can be thicker than the second thickness T2 before the gap distance 432 is reduced, such as seen when comparing FIG. 3 with FIG. 5. However, in some embodiments, the first thickness T1 can remain thicker than the second thickness T2 in the compressed state.

In some embodiments, reducing the gap distance 432 between the first press plate 424 and the second press plate 426 can sufficiently compress a portion of the packaged food product 314 resulting in the movement of the food material 316 within the packaged food product 314 between a first portion of the packaged food product 314 having first thickness T1 and a second portion of the packaged food product 314 having second thickness T2. In some embodiments, the first portion can be thicker than the second portion before the gap distance 432 is reduced, such as seen when comparing FIG. 3 with FIG. 5.

In some embodiments, reducing the gap distance 432 between the first press plate 424 and the second press plate 426 can sufficiently compress a portion of the packaged food product 314 resulting in the movement of the food material 316 within the packaged food product 314 between a bottom half 560 and a top half 562. In some embodiments, at least about 1, 2, 3, 5, 7.5 10, 15, 20, 25 percent of the total amount of food material in the packaged food product, by weight, can move from the bottom half 560 to the top half 562 as a result of compressing a portion of the packaged food product 314. In some embodiments, the amount of food material moving from the bottom half 560 to the top half 562 can fall within a range between any of the foregoing amounts.

As before, the first sheet 106 and the second sheet 108 can meet each other at a particular angle 450 near the top end 104. However, in some embodiments when the press plates compress a portion of the packaged food product, the angle 450 can change. Specifically, the angle 450 can increase. In some embodiments, the angle (for example, as measured at a mid-point laterally across the package) can increase by about 1, 2, 3, 5, 7.5, 10, 12.5, 15, 17.5, 20, 25, 30, 40, or 50 degrees or more. In some embodiments, the angle 450 can increase by a number of degrees falling within a range between any of the foregoing numbers.

In some embodiments, reducing the gap distance 432 between the first press plate 424 and the second press plate 426 sufficiently to compress a portion of the hermetically sealed packaged food product 314 results in decreasing the maximum thickness of the hermetically sealed food package from a starting point before compression by at least 5, 10, 15, 20, 25, 30, 40, 50, 60, 70, or 80 percent or more. In some embodiments, the maximum thickness can be reduced by a percentage falling within a range between any of the foregoing percentages.

The packaged food product 314 can be subjected to energy waves 320. The packaged food product 314 can obtain a more uniform thickness resulting in more uniform sterilization or pasteurization of the packaged food product 314. In comparing FIG. 3 with FIG. 5, it can be seen that the more uniform thickness shown in FIG. 5 will result the food material 316 being exposed to a more consistent amount of energy waves throughout the packaged food product 314.

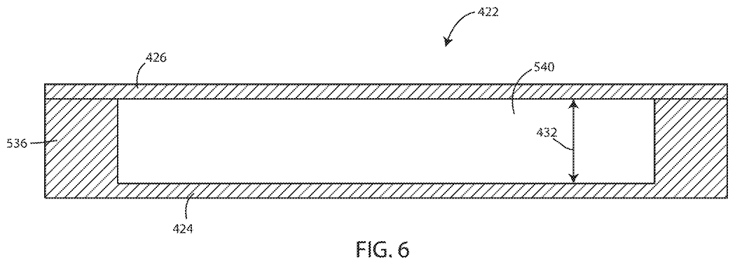

FIG. 6 shows a cross-sectional view of a carrier 422, according to various embodiments. The carrier 422 shown in FIG. 6 can represent a carrier 422 that is in a processing configuration, such that the gap distance 432 is narrowed.

The carrier 422 can include a first press plate 424, a second press plate 426, and a carrier frame 536. In some embodiments the carrier frame 536 can be integral with the first press plate 424 or the second press plate 426. In other embodiments, the carrier frame 536 can be attached or coupled to the first press plate 424 or the second press plate 426.

In some embodiments, the inner surface 428 of the first press plate 424 and the inner surface 430 of the second press plate 426 can be planar or flat. In some embodiments, the inner surface 428 of the first press plate 424 and the inner surface 430 of the second press plate 426 can be parallel.

The carrier 422 can define one or more interior openings 540. The interior opening 540 can be configured to receive a packaged food product 314. In some embodiments, the interior opening 540 can be a rectangular prism. In some embodiments, the height (distance from inner surface 428 of the first press plate 424 to the inner surface 430 of the second press plate 426) of the interior opening 540 can be less than half of the width or length of the interior opening 540.

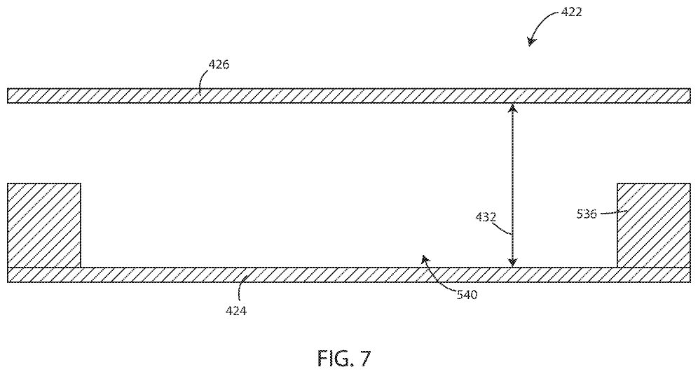

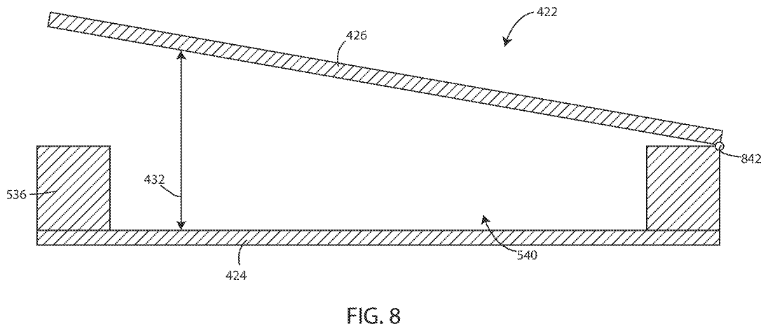

FIGS. 7 and 8 show cross-section views of carriers 422, according to some embodiments. The carriers 422 shown in FIGS. 7 and 8 can represent carriers 422 that are in a loading configuration, such that the gap distance 432 can be reduced, such as to form a packaged food product 314 into a more uniform thickness.

In some embodiments of a carrier 422 in a loading configuration, a portion of the carrier 422 that encloses the interior opening 540 can be removed or positioned away from the interior opening 540 to allow access to the interior opening 540. In the loading configuration a packaged food product 314 can be loaded into the one or more interior openings 540.

FIG. 7 shows an embodiment of a carrier 422. In some embodiments, the second press plate 426 can be separated from the remainder of the carrier 422. The second press plate 426 can be separated from the carrier frame 536, such as to allow a packaged food product 314 to be loaded into the interior opening 540.

It will be appreciated that movement of the first press plate 424 and the second press plate 426 with respect to one another can be accomplished in many different ways and through many different mechanisms that are contemplated herein. In some embodiments, the movement can be achieved through a pressing motion, linear movement, rotational movement, and the like. Referring now to FIG. 8, an embodiment of a carrier 422 is shown in accordance with various embodiments herein. In some embodiments, the second press plate 426 can be coupled to the remainder of the carrier 422 or to the carrier frame 536 with a hinge mechanism 842. The hinge mechanism 842 can be configured to allow the second press plate 426 to rotate away from the carrier frame 536 thereby allowing access to the one or more interior openings 540. The gap distance 432 between the first press plate 424 and the second press plate 426 can vary as the second press plate 426 is rotated.

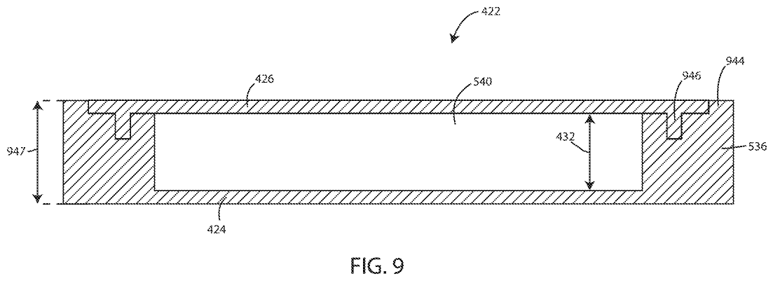

FIG. 9 shows a cross-sectional view of a carrier 422, according to various embodiments. In some embodiments, the carrier frame 536 can have an outer circumferential member 944. The outer circumferential member 944 can have a thickness 947 that is greater than the smallest gap distance 432 between the inner surface 428 of the first press plate 424 and the inner surface 430 of the second press plate 426. In some embodiments, a portion of the carrier frame 536 can be disposed between the first press plate 424 and the second press plate 426, and a portion of the carrier frame 536 extends beyond the first press plate 424 and the second press plate 426.

In some embodiments, a fastener 946 can couple the second press plate 426 to the carrier frame 536. The fastener 946 can temporarily couple the second press plate 426 to the carrier frame 536 (or the first press plate 424) such as to prevent the second press plate 426 from moving away from the remainder of the carrier 422. When the fastener 946 restricts the second press plate 426 from moving relative to the remainder of the carrier 422, the carrier 422 is in the processing configuration. In some embodiments, the fastener 946 can include a microwave and/or radiofrequency transparent material. In some embodiments, the fastener 946 can be a bolt, a screw, or a snap-fit connector. In some embodiments, the fastener 946 can be integral with one or more of the first press plate 424, the second press plate 426, or the carrier frame 536. In some embodiments, the fastener 946 can be separate from one or more of the first press plate 424, the second press plate 426, and/or the carrier frame 536.

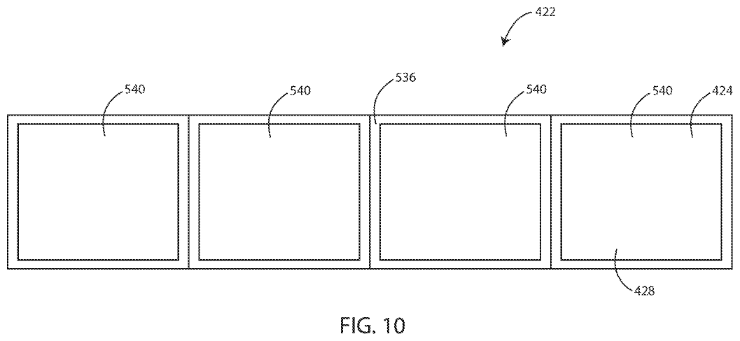

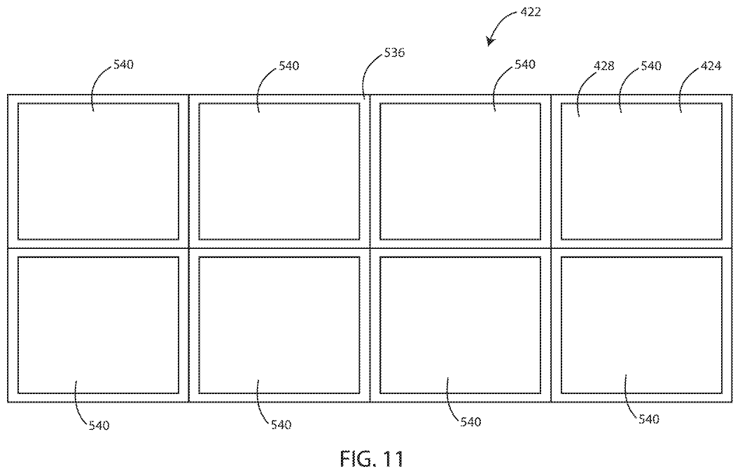

FIGS. 10 and 11 show a top views of a carrier 422 without the second press plate 426 or in a loading configuration where the second press plate 426 has been separated or removed from the remainder of the carrier 422, according to various embodiments. The carrier frame 536 can define a plurality of interior openings 540. In some embodiments, the interior openings 540 can all be the same as each other, such that the dimensions of each interior opening 540 are the same as the dimensions of other interior openings 540. In various embodiments, the interior openings 540 can be in a row, such as shown in FIG. 10. In various embodiments, the interior openings 540 can be in a grid pattern, such as shown in FIG. 11. In some embodiments, the grid pattern can include at least two rows of interior openings 540 and at least two columns of interior openings 540.

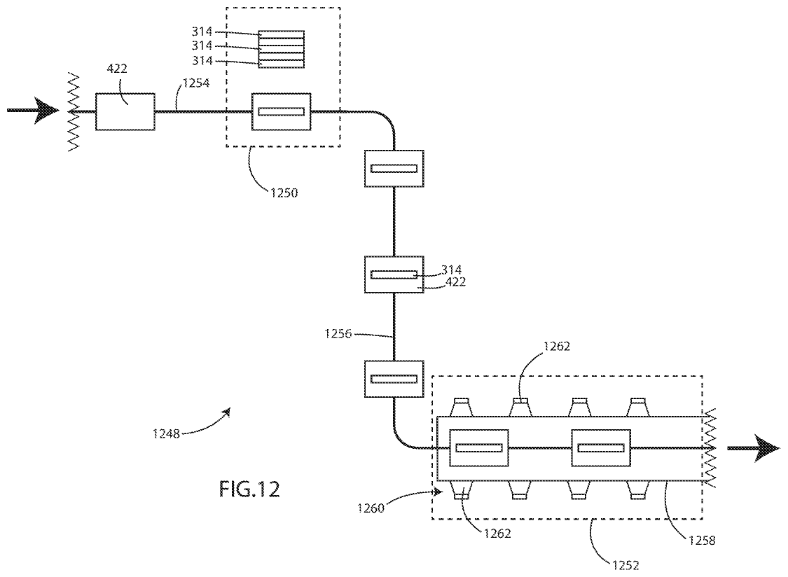

FIG. 12 shows a schematic of a packaged food product processing system 1248, according to various embodiments. The system 1248 can include one or more carriers 422, a loading station 1250, a processing station 1252, and a product conveyor mechanism 1254.

The product conveyor mechanism 1254 can be configured to convey carriers 422 to be processed continuously along a conveyance path 1256. The conveyance path 1256 can include passing through the loading station 1250 and the processing station 1252. In some embodiments, the conveyor mechanism 1254 can include a conveyor belt, a mechanical track, or a plurality of motorized rollers. Various other conveyor mechanism are also possible.

The loading station 1250 can include a plurality of packaged food products 314 that are ready to be disposed within a carrier 422. In some embodiments, the loading station 1250 can be configured to dispose a packaged food product 314 into the interior opening 540 of a carrier 422 in the loading configuration. In various embodiments, the conveyor mechanism 1254 can supply the loading station 1250 with one or more carriers 422. The carriers 422 can be in the loading configuration when the carriers 422 enter the loading station 1250. In some embodiments, the carriers 422 can be switched into the loading configuration within the loading station 1250.

The product conveyor mechanism 1254 can convey or transport the carriers 422 that have been loaded with a packaged food product 314 from the loading station 1250 to the processing station 1252.

In various embodiments, the processing station 1252 can include a sterilization or pasteurization chamber 1258. In some embodiments, the carriers 422 can be in the processing configuration when the carriers 422 enter the processing station 1252. In other embodiments, the carriers 422 can be switched to the processing configuration within the processing station 1252.

In some embodiments, the chamber 1258 can be at least partially filed with a liquid. In some embodiments, the carriers 422 can be completely submerged within the liquid while in the chamber 1258.

In some embodiments, the processing station 1252 can include an electromagnetic wave emitting apparatus 1260 configured to emit electromagnetic energy into the packaged food product 314. In various embodiments, the electromagnetic wave emitting apparatus 1260 can include one or more electromagnetic wave units 1262. In some embodiments, the electromagnetic wave units 1262 can include microwave energy emitters. In some embodiments, the electromagnetic wave units 1262 can include radiofrequency energy emitters.

In various embodiments, the electromagnetic wave units 1262 can include at least two electromagnetic wave units 1262 disposed on opposite sides of the product conveyor mechanism 1254 from each other, such as to emit energy towards the packaged food product 314 from at least two directions. In various embodiments, the electromagnetic wave units 1262 can include at least one top electromagnetic wave unit 1262 configured to emit energy downward into the packaged food product 314 and at least one bottom electromagnetic wave unit 1262 configured to emit energy upward into the packaged food product 314.

Electromagnetic wave energy can include energy at various frequencies. For example, electromagnetic wave energy can be applied at a frequency from approximately 300 MHz to approximately 2550 MHz or between 800 MHz to approximately 2550 MHz. In some embodiments, electromagnetic wave energy can be applied at a frequency of about 915 MHz or about 2450 Mhz. In some embodiments, electromagnetic wave energy can be applied at a frequency of about 13.56 MHz to 300 MHz.

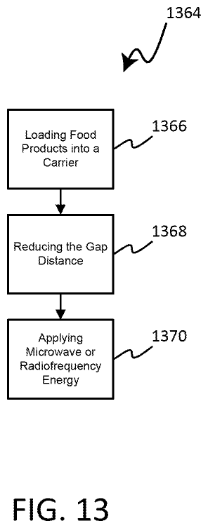

FIG. 13 shows a flow chart depicting a method 1364 of processing a packaged food product with microwave or radiofrequency energy to achieve sterilization or pasteurization, according to some embodiments. The method 1364 can include loading one or more packaged food products into a carrier, 1366. In some embodiments, loading one or more packaged food products into the carrier can include loading at least two packaged food products into the carrier. The packaged food products can have a non-uniform thickness when loaded into the carrier or when resting in the carrier. The carrier can include two press plates as described above.

The method 1364 can include reducing the gap distance between the first press plate and the second press plate, 1368. The gap distance can be reduced sufficiently to compress a portion of the packaged food product, such as to achieve a more uniform thickness. In some embodiments, reducing the gap distance between the first press plate and the second press plate sufficiently to compress a portion of the packaged food product can result in narrowing a first portion of the packaged food product and widening a second portion of the packaged food product. In various embodiments, prior to reducing the gap distance the first portion was thicker than the second portion.

In some embodiments, reducing the gap distance between the first press plate and the second press plate sufficiently to compress a portion of the packaged food product results in the movement of the food material within the packaged food product between a first portion of the packaged food product and a second portion of the packaged food product. In various embodiments, prior to reducing the gap distance the first portion was thicker than the second portion.

The method 1364 can further include applying at least one of microwave or radiofrequency energy to the packaged food product to result in sterilization or pasteurization of the packaged food product, 1370.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

The technology has been described with reference to various specific and preferred embodiments and techniques. However, it should be understood that many variations and modifications may be made while remaining within the spirit and scope of the technology. As such, the embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

1. A method of processing a hermetically sealed packaged food product with microwave or radiofrequency energy to achieve sterilization or pasteurization comprising:
loading one or more hermetically sealed packaged food products into a carrier,
the hermetically sealed packaged food products having a non-uniform thickness;
the carrier comprising a first press plate comprising an inner surface, the first press plate comprising a microwave and radiofrequency transparent material;
a second press plate comprising an inner surface, the second press plate comprising a microwave and radiofrequency transparent material;
wherein the inner surface of the first press plate and the inner surface of the second press plate are spaced apart from one another by a gap distance;
reducing the gap distance between the first press plate and the second press plate sufficiently to compress a portion of the hermetically sealed packaged food product; and
applying at least one of microwave or radiofrequency energy to the hermetically sealed packaged food product to result in sterilization or pasteurization of the hermetically sealed packaged food product.

2. The method of claim 1, wherein reducing the gap distance between the first press plate and the second press plate sufficiently to compress a portion of the hermetically sealed packaged food product results in narrowing a first portion of the hermetically sealed packaged food product and widening a second portion of the hermetically sealed packaged food product, wherein the first portion is thicker than the second portion before the gap distance is reduced.

3. The method of claim 1, wherein reducing the gap distance between the first press plate and the second press plate sufficiently to compress a portion of the hermetically sealed packaged food product results in the movement of a food material within the hermetically sealed packaged food product between a first portion of the hermetically sealed packaged food product and a second portion of the hermetically sealed packaged food product, wherein the first portion is thicker than the second portion before the gap distance is reduced.

4. The method of claim 1, wherein reducing the gap distance between the first press plate and the second press plate sufficiently to compress a portion of the hermetically sealed packaged food product results in increasing an angle defining the point where a first sheet and a second sheet are joined together to form the top end of the sealed package food product.

5. The method of claim 1, wherein reducing the gap distance between the first press plate and the second press plate sufficiently to compress a portion of the hermetically sealed packaged food product results in increasing an angle defining the point where a first sheet and a second sheet are joined together to form the top end of the sealed package food product by at least 5 degrees.

6. The method of claim 1, wherein reducing the gap distance between the first press plate and the second press plate sufficiently to compress a portion of the hermetically sealed packaged food product results in decreasing the maximum thickness of the hermetically sealed food package from a starting point before compression by at least 10 percent.

7. The method of claim 1, wherein reducing the gap distance between the first press plate and the second press plate sufficiently to compress a portion of the hermetically sealed packaged food product causes movement of the food material within the packaged food product between a bottom half of the hermetically sealed packaged food product and a top half of the hermetically sealed packaged food product of at least about 5 percent of the total amount of food material in the packaged food product by weight.

8. The method of claim 1, wherein the food material is a flowable food material.

9. The method of claim 1, wherein the hermetically sealed packaged food product contains less than 20% air by volume.

10. The method of claim 1, wherein loading one or more hermetically sealed packaged food products into a carrier comprises loading at least two hermetically sealed packaged food products into the carrier.

11. A carrier for holding packaged food products during a sterilization or pasteurization process conducted in a radiofrequency or microwave system comprising:
a first press plate comprising an inner surface, the first press plate comprising a microwave and radiofrequency transparent material;
a second press plate comprising an inner surface, the second press plate comprising a microwave and radiofrequency transparent material;
wherein the inner surface of the first press plate and the inner surface of the second press plate are spaced apart from one another by a gap distance;
the carrier configured to be switched between a loading configuration where the gap distance is expanded to allow placement of a packaged food product into the carrier and a processing configuration where the gap distance is contracted to apply pressure to a portion of the packaged food product and change its shape.

12. The carrier of claim 11, further comprising a carrier frame, the carrier frame comprising a microwave and radiofrequency transparent material and be configured connected to the first press plate and the second press plate.

13. The carrier of claim 12, the carrier frame configured to fit at least partially between the first press plate and the second press plate.

14. The carrier of claim 13, the carrier frame comprising a portion having a thickness defining the smallest gap distance between the inner surface of the first press plate and the inner surface of the second press plate.

15. The carrier of claim 12, the carrier frame defining one or more interior openings into which non-uniform thickness packaged food products can be disposed.

16. The carrier of claim 12, the carrier frame further comprising an outer circumferential member comprising a thickness that is greater than the smallest gap distance between the inner surface of the first press plate and the inner surface of the second press plate.

17. A system for processing food products, comprising:
a carrier comprising a first press plate comprising an inner surface and a second press plate comprising an inner surface, wherein the inner surface of the first press plate and the inner surface of the second press plate are spaced apart from one another by a gap distance, the first press plate and the second press plate configured to be switched between a loading configuration where the gap distance can be expanded and a processing configuration where the gap distance cannot be expanded, wherein the first press plate and the second press plate both comprise microwave and radiofrequency transparent material;
a product conveyor mechanism to convey the one or more carriers to be processed continuously along a conveyance path passing through a loading station and a sterilization chamber;
a loading station configured to dispose a packaged food product into a carrier; and
a sterilization station comprising an electromagnetic wave emitting apparatus configured to emit electromagnetic energy into the packaged food product, the electromagnetic wave emitting apparatus comprising one or more electromagnetic wave units.

18. The system of claim 17, wherein the electromagnetic wave units comprise microwave energy emitters or radiofrequency energy emitters.

19. The system of claim 17, wherein the electromagnetic wave units comprise at least one top wave emitting unit configured to emit energy downward into the packaged food product and at least one bottom wave emitting unit configured to emit energy upward into the packaged food product.

20. The system of claim 17, wherein the electromagnetic wave units comprise at least two wave emitting units disposed on opposite sides of the product conveyor mechanism from each other.
